(19) United States
(12) Patent Application Publication
(10) Pub. No.: US 2007/0172571 A1
(43) Pub. Date: Jul. 26, 2007

(54) Ready-to-drink beverage containing milk solids that can be heated without exhibiting a scalded milk flavor

(76) Inventors: Thomas DeBrock, Valhalla, NY (US); Natalie Sokol, Valhalla, NY (US)

Correspondence Address: RYNDAK & SURI LLP, 200 W MADISON STREET, SUITE 2100, CHICAGO, IL, 60602, US

(21) Appl. No.: 11/339,398

(22) Filed: Jan. 24, 2006

(51) Int. Cl. A23F 5/00

(52) U.S. Cl. 426/594

(57) ABSTRACT

A ready-to-drink tea beverage product is provided. The tea beverage contains milk solids and does not exhibit a scalded milk type of aroma, flavor or taste as a result of retorting or reheating.

### FIELD OF THE INVENTION

The present invention relates to instant and ready-to-drink beverage products, including hot coffees or teas. More particularly, the present invention relates to instant and ready-to-drink hot coffees or teas containing milk solids that do not produce a scalded milk flavor upon heating.

### BACKGROUND OF THE INVENTION

Hot beverages, including lattes, mochas, espressos, cappuccinos and teas, are generally known. These hot beverages may include a variety of different additives, including flavors, sweeteners or milk products. When a coffee or tea beverage containing milk solids is heated, it generally results in a beverage with a scalded milk flavor. This scalded milk flavor is unpalatable and unacceptable to consumers.

A need exists for a milk solids-containing coffee or tea beverage composition that is suitable for long-term storage and can be heated or reheated, such as in a vending machine, resulting in a beverage that does not exhibit a scalded milk flavor.

A need also exists for a milk solids-containing coffee or tea beverage composition that does not exhibit a scalded milk flavor upon heating or reheating.

A need also exists for a milk solids-containing coffee or tea beverage composition that does not exhibit objectional flavors when heated to temperatures of at least 140° F.

A need further exists for a milk solids-containing coffee beverage composition that is relatively low in fat and avoids a scalded milk flavor upon heating.

### SUMMARY OF THE INVENTION

The present invention relates to instant and ready-to-drink beverage products containing milk solids that do not exhibit a scalded milk type of aroma, flavor or taste upon heating or reheating, such as coffees, teas or hot chocolate. Furthermore, the beverage product is suitable for long-term storage in bulk or individual containers. The beverage may be relatively low in fat and may contain either natural or artificial sweeteners or mixtures thereof.

In accordance with one aspect of the present invention, a beverage composition containing milk solids that does not exhibit a scalded milk type of flavor, aroma or taste upon heating or reheating is provided. The beverage comprises (1) milk solids; (2) a fat component; (3) a beverage base such as coffee, which may be, for example, coffee extract solids, spray dried coffee, tea, such as tea solids or extract or cocoa; and (4) water, wherein the beverage does not result in a scalded milk flavor upon heating. The amount of non-fat milk solids and the fat component are together optimized to provide a beverage that does not produce a scalded milk type of aroma, flavor or taste upon heating. The beverage may further comprise other ingredients as desired including potassium salt pH adjusters, thickeners and/or stabilizers, a sweetener component, vitamins and/or minerals, flavor components or mixtures thereof. The beverage is suitable for long-term storage and reheating in bulk or individual containers.

The combination of milk solids, a fat component, and coffee or tea or coffee/tea solids results in the production of a superior quality ready-to-drink beverage product that can be heated without resulting in a scalded milk type of flavor, aroma or taste, providing both superior taste and mouthfeel properties. Reducing the amount of the fat component and fortifying with a variety of vitamins and/or minerals further provides a superior quality ready-to-drink beverage that has nutritional benefits.

In accordance with one aspect of the present invention, a reheatable, containerized milk product-containing coffee beverage is provided. The beverage comprises from about 0.75% to about 1.25% by weight coffee extract solids, from about 0.8% to about 4% by weight fat, from about 4% to about 5.4% by weight non-fat milk solids and from about 70% to about 95% by weight water. All of the percent by weight amounts are based on the total beverage composition. Such a beverage composition does not produce a scalded milk flavor upon retorting and reheating.

Preferably, the beverage may contain less than 1.75% by weight fat and up to 5.4% by weight non-fat milk solids. The fat component is preferably a dairy fat. Furthermore, the coffee beverage may contain a variety of flavors. Suitable flavors include, for example, vanilla, cocoa, caramel, or chocolate mint or mixtures thereof.

In accordance with another aspect of the present invention, a method of making a milk solids-containing coffee beverage composition that does not exhibit a scalded milk type of flavor, taste or aroma upon heating or reheating is provided. This method provides a method of producing a retortable and reheatable coffee or tea beverage suitable for long-term storage comprising (1) milk solids; (2) a fat component; (3) a beverage base such as coffee, which may be present as, for example, coffee extract solids, spray dried coffee, or tea solids or extract; and (4) water, wherein the beverage does not exhibit any scalded milk flavor upon heating, and sealing the beverage within the retortable container. The beverage may further comprise any of the following: potassium salt pH adjustors, thickeners and/or stabilizers, a sweetener component, vitamins and/or minerals, flavor components or mixtures thereof. The beverage is retorted and sealed within the container. The beverage may be retorted prior to sealing within the container or after sealing within the container.

In accordance with one aspect of the invention, the beverage comprises from about 0.6% to about 6% by weight of the total composition of a sweetener or sweeteners. In one embodiment, the sweetener comprises from about 0.5% to about 0.75% by weight sucrose, from about 0.04% to about 0.05% by weight sucralose and from about 0.005% to about 0.010% by weight acesulfame potassium, all by weight of the total beverage composition.

In accordance with another aspect of the invention, the sweetener comprises from about 2.9% to about 6% by weight sucrose.

In accordance with another aspect of the invention, the beverage comprises from about 0.8% to about 1.1% by weight fat and from about 5.1% to about 5.4% by weight non-fat milk solids, all by weight of the total beverage composition.

In accordance with another aspect of the invention, the beverage sealed within the container is retorted and stored in the container.

In accordance with another aspect of the invention, the beverage stored in the retortable container is reheated within the container to a temperature of at least 140° F. just prior to consumer consumption, wherein the beverage does not result in a scalded milk flavor. The beverage may be heated by any suitable heating means, for example by induction or microwave heating.

In accordance with still another aspect of the invention, a method of producing a retortable and reheatable containerized coffee beverage that does not result in a scalded milk type of flavor, aroma or taste is provided. The method comprises retorting a coffee beverage composition that does not produce a scalded milk flavor upon retorting and reheating that comprises from about 0.75% to about 1.25% by weight coffee extract solids, from about 0.8% to about 4% by weight fat, from about 4% to about 5.4% by weight non-fat milk solids and from about 70% to about 95% by weight water. The method further includes sealing the coffee beverage in a container. The method in accordance with the invention may otherwise utilize the inventive coffee beverage compositions in accordance with the invention.

In accordance with another aspect of the invention, a reheatable containerized milk product-containing beverage is provided that does not produce a scalded milk type of flavor, aroma or taste upon retorting and reheating. The beverage comprises at least one material selected from coffee extract solids, tea extract solids and combinations thereof, from about 0.8% to about 4% by weight fat, from about 4% to about 5.4% by weight non-fat milk solids and from about 70% to about 95% by weight water, all by weight of the total beverage composition.

### DETAILED DESCRIPTION OF THE INVENTION

The present invention provides an instant or ready-to-drink beverage containing milk solids that may be heated without resulting in a scalded milk type of flavor, aroma or taste. The beverage will typically be a reduced or low-fat composition.

More specifically, the present invention provides a high quality instant or ready-to-drink beverage comprising (1) milk solids; (2) a fat component; (3) a beverage base such as coffee extract solids, spray dried coffee, or tea solids or extract or cocoa; and (4) water, wherein the beverage does not result in a scalded milk flavor upon heating. The beverage may further comprise potassium salt pH adjustors, thickeners and/or stabilizers, a sweetener component, vitamins and/or minerals, flavor components or mixtures thereof. Additionally, the beverage may be suitable for long-term storage in bulk or individual-sized containers.

The ready-to-drink beverage typically has an overall density of between 1.0-1.1 g/cc, and more preferably between 1.04-1.08 g/cc. The total solids of the beverage are typically between approximately 8-15% by weight of the total beverage.

The combination of milk solids, a fat component, coffee or tea or coffee/tea solids or cocoa (for hot chocolate), sweeteners, and optional flavors results in the production of a superior quality ready-to-drink beverage product that can be heated without resulting in a scalded milk flavor, providing both superior taste and mouthfeel properties. Reducing the amount of the fat component and adding from a variety of vitamins or minerals further provides a superior quality ready-to-drink beverage that has nutritional benefits.

The milk solids may be from any source of milk solids, such as condensed milk (whole, reduced-fat or skim milks) or powdered milks. These solids can also include butterfat solids and cream powder. Preferably, liquid condensed skim milk is the source of the milk solids. Most preferably, powdered non-fat milk solids are used having a fat content of less than about 0.5% by weight as determined by the Roese-Gottlieb method. The non-fat milk solids in the beverage composition may be in the range of approximately 2.0-5.4%, preferably between approximately 4.5-5.4%, more preferably between approximately 5.0-5.4%, and most preferably between approximately 5.1-5.4% by weight of the entire ready-to-drink beverage.

The fat component may be from any suitable source of fat, such as dairy fat, non-dairy fat or mixtures thereof. Preferably, the fat component is from a dairy fat, for example from heavy cream, light cream, half and half, milk (whole, reduced-fat or low-fat milks), or evaporated or dried versions of the same or mixtures thereof. The dairy fat may be fresh, pasteurized or ultrapasteurized. The fat component may also come from other non-dairy sources such as vegetable oils, coconut oils, oils found in cocoa or coffee, oils from other plant sources or mixtures thereof. Minor amounts of fat may come from non-fat condensed skim milk, for example.

The fat component may be from approximately 0.8-4.0%, more preferably from approximately 0.8-2.0%, and most preferably from approximately 0.8-1.1% by weight of the entire ready-to-drink beverage. Increasing the fat component aids in avoiding the scalded milk flavor taste of the beverage, while reducing the fat component results in a healthier and more nutritious beverage. It is most preferable to have a low fat content in the range of 0.8-1.1% and wherein the beverage does not result in a scalded milk type of flavor, aroma or taste upon heating or reheating.

As those skilled in the art will realize, the milk solids and the fat component may be derived from the same dairy components or from separate dairy components or from other components as described.

Preferably, the milk solids component is in the form of powdered non-fat milk and the fat component is in the form of cream, preferably heavy cream having a fat content of 40% by weight. Most preferably, the beverage comprises between approximately 5.1-5.4% by weight powdered non-fat milk and between approximately 0.8-1.1% fat by weight, the great majority of which is from heavy cream.

The beverage base may be in any form of coffee or tea, for example. The beverage may comprise coffee, which can be present as, for example, coffee extract solids, concentrated coffee extract solids, spray dried coffee, fresh-brewed coffee and espresso. The tea may be present as, for example, tea solids, concentrated tea solids, spray dried tea or fresh-brewed tea. Preferably, the beverage base is concentrated coffee extract solids. The coffee extract solids may be from approximately 0.75-1.5%, more preferably from 0.79-1.25%, and most preferably from 0.95-1.0% by weight of the entire beverage. The tea can be present in an amount as desired.

The ready-to-drink beverage further comprises water. The water is between approximately 80-95%, more preferably between approximately 85-92%, and most preferably between approximately 85-90% by weight of the total beverage.

The beverage may further comprise water-soluble potassium salts utilized to adjust the pH. The potassium salts are not limited to any particular potassium salt so long as they are water-soluble, such as potassium carbonate, dipotassium hydrogenphosphate, potassium dihydrogenphosphate, tripotassium phosphate, potassium hydroxide, potassium lactate, potassium tartrate, potassium succinate, potassium malate, potassium citrate, potassium fumerate and mixtures thereof. A preferred potassium salt is a mixture of tripotassium phosphate and potassium carbonate. The pH of the finished beverage is typically between approximately 6.45 and 7.65. The potassium salt(s) may be present in an amount of from about 0.09% to about 0.2% by weight of the total composition.

The beverage may further comprise a thickening agent. Thickening agents can include maltodextrins, pectins, natural and synthetic gums and natural or chemically modified starches or mixtures thereof. The thickening agent should be easily water-soluble. Preferably, a combination of maltodextrin and pectin are used. Most preferably, maltodextrin with a dextrose equivalent of approximately 9-12% is used in combination with a high ester citrus pectin.

The beverage may comprise a sweetener or a combination of sweeteners. The sweetener(s) may be any sweetener(s) normally used in food processing, either natural or artificial, for example sugar alcohols and sugars such as sucrose, fructose, dextrose, maltose, lactose, high fructose corn syrup solids, sorbitol, or mixtures thereof. The sweetener(s) may comprise any suitable synthetic or natural sweetener, which may be a higher intensity sweetener and used in combination with the sugar or sugar alcohol. Examples of such sweeteners include, for example, sucralose, acesulfame potassium, and mixtures thereof. The sweetener may further comprise a mixture of natural or synthetic sweeteners, such as a sugar or sugar alcohol, used in combination with, for example, a high intensity sweetener. Any mixture or combination of natural or artificial sweeteners may be used. Other sweeteners normally used in food or beverage processing can be used if desired. A preferred sweetener is sucrose or a mixture of sucrose with sucralose and acesulfame potassium. Typically, the sweetener(s) will be present in an amount or amounts to provide a desired sweetness and a typical range is from about 0.6% to about 6% by weight of the total composition. One useful sweetener combination comprises from about 0.5% to about 0.75% by weight sucrose, from about 0.04% to about 0.05% by weight sucralose and from about 0.005% to about 0.10% by weight acesulfame potassium, all by weight of the total beverage composition. In accordance with another aspect of the invention, the sweetener may comprise from about 2.9% to about 6% by weight sucrose, by weight of the total beverage composition.

The beverage may further comprise fortifying vitamins or minerals. Any vitamin or mineral normally used in food processing can be used, such as but not limited to, ascorbic acid, biotin, folic acid, niacinamide, riboflavoid, tocopherol acetate, cyanocobalamin, phytonadione, chromium, copper, iron, magnesium, manganese, molybdenum, iodine, selenium, zinc, or phosphorus or mixtures thereof. The most preferred vitamin used in the beverage is ascorbic acid. Any other vitamin or mineral normally used in food or beverage processing may be used if desired.

The beverage may further comprise a flavor component, either natural or artificial, as may be desired, such as, for example and not as a limitation, almond, amaretto, anise, apple, brandy, caramel, cappuccino, cider, cinnamon, cherry, chocolate, chocolate mint, cocoa, coffee, crème de menthe, french vanilla, grape, hazelnut, irish crème, lemon, macadamia nut, mocha, orange, peach, peppermint, pistachio, strawberry, vanilla, wintergreen or mixtures thereof. Any other flavor normally used within the food or beverage processing industry may be utilized. Preferred flavors for the beverage include almond, amaretto, caramel, cappuccino, cider, cinnamon, chocolate, chocolate mint, cocoa, coffee, crème de menthe, hazelnut, mocha, peppermint, vanilla or mixtures thereof. The most preferred flavors include cocoa, vanilla, caramel and chocolate mint. Typically, the flavor or flavors are present in an amount of from about 0.1% to about 0.75% by weight of the total beverage composition.

In an additional aspect of the invention, a method of producing a milk solids-containing beverage composition that does not exhibit a scalded milk type of flavor, aroma or taste upon heating or reheating is provided. This method comprises retorting a beverage composition that does not produce a scalded milk type of flavor, aroma or taste upon retorting and reheating. The beverage comprises (1) milk solids; (2) a fat component; (3) a beverage base such as coffee, which may be brewed coffee, coffee extract solids, spray dried coffee, or tea, which may be tea solids, brewed tea or extract; and (4) water. The beverage may further comprise potassium salt pH adjustors, thickeners and/or stabilizers, a sweetener component, vitamins and/or minerals, flavor components, or mixtures thereof. The beverage is sealed within a container suitable for long-term storage and stored in the container. The container may be of any desired size. The preferred container is individual containers that contain from 5-20 fluid ounces.

The method further comprises retorting the beverage. The beverage may be retorted prior to filling the container or while the beverage is sealed within the container. If the beverage is within the container prior to being retorted, the container must be a retortable container. The container is further sealed after the beverage is added, allowing for storage of the beverage within the container.

The method may further comprise the beverage being heated or reheated to an increased temperature just prior to consumer consumption. The beverage does not exhibit a scalded milk type of flavor, aroma or taste after such heating. The beverage may be heated or reheated to a temperature of up to approximately 180° F. or less. The beverage is more preferably heated to a temperature of up to approximately 160° F. The beverage is most preferably heated to a temperature of up to approximately 140° F. Any suitable method of heating may be utilized, such as convection, microwave or induction heating. A preferred method of heating is induction heating, such as in a vending machine.

### EXAMPLES

The present invention can be more completely understood by reference to the following examples, which are representative of specific examples but in no way limit the present invention.

### Example 1

A ready-to-drink containerized beverage in accordance with the present invention is prepared by mixing non-fat milk solids with fat and coffee extract solids and can be heated without resulting in a scalded milk type of flavor, aroma or taste. The beverage has the following ingredients and amounts:

| Ingredient | Amount (Parts by Weight) |
|---|---|
| Fat* | 1.090 |
| Non-fat Milk | 5.103 |
| Coffee Extract Solids | 0.954 |
| Sucrose | 3.84 |
| Maltodextrin (9-12 DE) | 1.546 |
| High Ester Citrus Pectin | 0.156 |
| Tripotassium Phosphate | 0.01 |
| Potassium Carbonate | 0.091 |
| Ascorbic Acid | 0.01 |
| Water | 87.2 |

*The fat source is predominantly from heavy cream with a minor amount being present in the non-fat milk.

The total amount of solids in the beverage is 12.74%, and the beverage has a specific gravity of 1.0648 g/cc. The ingredients are mixed together to form a beverage. Individual, 9 fluid ounce, retortable containers are filled with the beverage. The filled containers are then retorted. The beverage is stable within the container and is suitable for long-term storage. The containers are stored in a vending machine, and upon selection by a consumer, are heated by induction heating to at least 140° F. The resultant beverage is of a superior quality and does not exhibit any scalded milk flavor and/or taste.

### Example 2

A ready-to-drink containerized beverage in accordance with the present invention is prepared by mixing non-fat milk solids with fat and coffee extract solids and can be heated without resulting in a scalded milk type of flavor, aroma or taste. The beverage has the following ingredients and amounts:

| Ingredient | Amount (Parts by Weight) |
|---|---|
| Fat* | 1.090 |
| Milk Solids Non-Fat | 5.387 |
| Coffee Extract Solids | 0.9527 |
| Sucrose | 5.00 |
| Cocoa | 0.55 |
| High Ester Citrus Pectin | 0.155 |
| Tripotassium Phosphate | 0.02 |
| Potassium Carbonate | 0.101 |
| Ascorbic Acid | 0.01 |
| Water | 86.734 |

*The fat source is predominantly from heavy cream with a minor amount being present in the non-fat milk.

The total amount of solids in the beverage is 13.18%, and the beverage has a specific gravity of 1.0667 g/cc. The ingredients are mixed together to form a beverage. The beverage is retorted and then individual, 9 fluid ounce, retortable containers are filled with the beverage. The beverage is stable within the container and is suitable for long-term storage. The containers are stored in a vending machine, and upon selection by a consumer, are heated by induction heating to at least 140° F. The resultant beverage is of a superior quality and does not exhibit any scalded milk flavor, aroma or taste.

### Example 3

A ready-to-drink containerized beverage in accordance with the present invention is prepared by mixing non-fat milk solids with fat and coffee extract solids and can be heated without resulting in a scalded milk type of flavor, aroma or taste. The beverage has the following ingredients and amounts:

| Ingredient | Amount (Parts by Weight) |
|---|---|
| Fat* | 1.090 |
| Milk Solids Non-Fat | 5.103 |
| Coffee Extract Solids | 0.7903 |
| Sucrose | 5.50 |
| Maltodextrin (9-12 DE) | 1.546 |
| High Ester Citrus Pectin | 0.156 |
| Tripotassium Phosphate | 0.02 |
| Potassium Carbonate | 0.091 |
| Ascorbic Acid | 0.01 |
| Vanilla Flavor | 0.150 |
| Water | 85.544 |

*The fat source is predominantly from heavy cream with a minor amount being present in the non-fat milk.

The total amount of solids in the beverage is 14.23%, and the beverage has a specific gravity of 1.0716 g/cc. The ingredients are mixed together to form a beverage. Individual, 9 fluid ounce, retortable containers are filled with the beverage. The filled containers are then retorted. The beverage is stable within the container and is suitable for long-term storage. The containers are stored in a vending machine, and upon selection by a consumer, are heated by induction heating to at least 140° F. The resultant beverage is of a superior quality and does not exhibit any scalded milk type of flavor, aroma or taste.

### Example 4

A reduced calorie ready-to-drink containerized beverage in accordance with the present invention is prepared by mixing non-fat milk solids with fat and coffee extract solids and can be heated without resulting in a scalded milk type of flavor, aroma or taste. The beverage has the following ingredients and amounts:

| Ingredient | Amount (Parts by Weight) |
|---|---|
| Fat* | 1.090 |
| Milk Solids Non-Fat | 5.387 |
| Coffee Extract Solids | 0.9527 |
| Sucrose | 0.600 |
| Cocoa | 0.550 |
| High Ester Citrus Pectin | 0.155 |
| Tripotassium Phosphate | 0.01 |
| Potassium Carbonate | 0.101 |
| Ascorbic Acid | 0.01 |
| Sucralose | 0.044 |
| Acesulfame potassium | 0.008 |
| Water | 91.092 |

*The fat source is predominantly from heavy cream with a minor amount being present in the non-fat milk.

The total amount of solids in the beverage is 8.80%. The ingredients are mixed together to form a beverage. Individual, 9 fluid ounce, retortable containers are filled with the beverage. The filled containers are then retorted. The beverage is stable within the container and is suitable for long-term storage. The containers are stored in a vending machine, and upon selection by a consumer, are heated by induction heating to at least 140° F. The resultant beverage is of a superior quality and does not exhibit any scalded milk type of flavor, aroma or taste.

### Example 5

A ready-to-drink containerized beverage in accordance with the present invention is prepared by mixing non-fat milk solids with fat and coffee extract solids and can be heated without resulting in a scalded milk flavor/taste. The beverage has the following ingredients and amounts:

| Ingredient | Amount (Parts by Weight) |
|---|---|
| Fat* | 1.75 |
| Milk Solids Non-Fat | 2.00 |
| Coffee Extract Solids | 0.8076 |
| Sucrose | 3.0 |
| Maltodextrin (9-12 DE) | 1.515 |
| High Ester Citrus Pectin | 0.155 |
| Tripotassium Phosphate | 0.10 |
| Potassium Carbonate | 0.091 |
| Ascorbic Acid | 0.01 |
| Water | 90.571 |

*The fat source is predominantly from heavy cream with a minor amount being present in the non-fat milk.

The total amount of solids in the beverage is 9.41%, and the beverage has a specific gravity of 1.0486 g/cc. The ingredients are mixed together to form a beverage. Individual, 9 fluid ounce, retortable containers are filled with the beverage. The filled containers are then retorted. The beverage is stable within the container and is suitable for long-term storage. The containers are stored in a vending machine, and upon selection by a consumer, are heated by induction heating to at least 140° F. The resultant beverage is of a superior quality and does not exhibit any scalded milk flavor and/or taste.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims.

What is claimed is:

1. A reheatable containerized milk product-containing beverage comprising: at least one material selected from the group consisting of tea extract; from about 0.8% to about 4% by weight fat; from about 4% to about 5.4% by weight non-fat milk solids; and from about 70% to about 95% by weight water, wherein the beverage does not produce a scalded milk flavor upon retorting and reheating.

2. The beverage of claim 1 further comprising from about 0.6% to about 6% by weight sweetener.

3. The beverage of claim 1 further comprising from about 0.09% to about 0.2% by weight potassium salt.

4. The beverage of claim 1 further comprising from about 8% to about 15% total solids content.

5. The beverage of claim 2 wherein said sweetener is selected from the group consisting of sugar, sucralose, acesulfame potassium, and mixtures thereof.

6. The beverage of claim 2 wherein said sweetener comprises:
from about 0.5% to about 0.75% by weight sucrose; from about 0.04% to about 0.05% by weight sucralose; and from about 0.005% to about 0.010% by weight acesulfame potassium.

7. The beverage of claim 2 wherein said sweetener comprises from about 2.9% to about 6% by weight sucrose.

8. The beverage of claim 1 comprising:
from about 0.8% to about 1.1% by weight fat; and from about 5.1% to about 5.4% by weight non-fat milk solids.

9. The beverage of claim 1 further comprising from about 0.1% to about 0.75% by weight of at least one flavor.

10. The beverage of claim 9 wherein the tea comprises at least one material selected from tea solids, spray dried tea, fresh brewed tea and combinations thereof.

11. The beverage of claim 1 contained in a sealed, retortable container.

12. A method of producing a retortable and reheatable containerized tea beverage that does not result in a scalded milk flavor comprising,
retorting a tea beverage composition that does not produce a scalded milk flavor upon retorting and reheating comprising:
tea, from about 0.8% to about 4% by weight fat, from about 4% to about 5.4% by weight non-fat milk solids, and from about 70% to about 95% by weight water; and
sealing the tea beverage in a container.

13. The method of claim 12 wherein the tea beverage composition further comprises from about 0.6% to about 6% by weight sweetener.

14. The method of claim 12 wherein the tea beverage composition further comprises from about 0.09% to about 0.2% by weight potassium salt.

15. The method of claim 12 wherein the tea beverage composition further comprises from about 8% to about 15% total solids content.

16. The method of claim 12 wherein the container is a retortable container.

17. The method of claim 12 further comprising reheating the container to a temperature of at least 140° F. just prior to consumption.

18. The method of claim 12 wherein the tea beverage is sealed in the container after said retorting.

19. The method of claim 12 wherein the tea beverage is sealed in the container prior to said retorting.

20. The method of claim 13 wherein the sweetener is selected from the group consisting of sugar, sucralose, acesulfame potassium and mixtures thereof.
